(19) United States
(12) Patent Application Publication
(10) Pub. No.: US 2026/0282026 A1
(43) Pub. Date: Sep. 17, 2026

(54) METHODS AND APPARATUS FOR USER EQUIPMENT-INITIATED UPLINK CONTROL INFORMATION REPORTING IN MOBILE COMMUNICATIONS

(71) Applicant: MEDIATEK INC., Hsinchu City (TW)

(72) Inventors: Yi-Ru CHEN, Hsinchu City (TW); Cheng-Rung TSAI, Hsinchu City (TW)

(73) Assignee: MEDIATEK INC., Hsinchu City (TW)

(21) Appl. No.: 19/473,790

(22) PCT Filed: Dec. 5, 2024
(86) PCT No.: PCT/CN2024/137025

§ 371 Date: Oct. 8, 2025

Related U.S. Application Data
(60) Provisional application No. 63/606,633, filed on Dec. 6, 2023.

(51) Int. Cl. H04W 72/21; H04W 74/0833

(52) U.S. Cl. CPC H04W 72/21; H04W 74/0833

(57) ABSTRACT

Various solutions for user equipment-initiated uplink control information (UCI) reporting with respect to user equipment in mobile communications are described. An apparatus may transmit an uplink (UL) indication associated with an UL resource to a network node in an event that an uplink control information (UCI) reporting is triggered by the apparatus. The UCI reporting may be a channel state information (CSI) reporting, a beam reporting, or a combination thereof. The apparatus may transmit a UCI such as the CSI or the beam information in the UL resource to the network node.

### CROSS REFERENCE TO RELATED PATENT APPLICATION(S)

The present disclosure is part of a non-provisional application claiming the priority benefit of U.S. Patent Application No. 63/606,633, filed 6 Dec. 2023, the content of which herein being incorporated by reference in its entirety.

### TECHNICAL FIELD

The present disclosure is generally related to mobile communications and, more particularly, to user equipment (UE)-initiated uplink control information (UCI) reporting with respect to user equipment in mobile communications.

### BACKGROUND

Unless otherwise indicated herein, approaches described in this section are not prior art to the claims listed below and are not admitted as prior art by inclusion in this section.

Channel state information (CSI) is the information about the wireless channel condition between the transmitter and receiver in a fifth generation (5G) new radio (NR) wireless network. Conventionally, the periodicity of CSI measurement and CSI reporting is determined and configured by the base station (e.g., gNB). That is, the CSI reporting and its corresponding uplink (UL) resource allocation are always network-triggered or network-scheduled. This often leads to substantial delays in beam reporting due to the lack of timely UL resources for carrying the report or the network's unawareness of the need for immediate triggering or activation of CSI reporting. To mitigate these latency issues, allocating more UL resources could be considered. However, this approach can increase reporting overhead. Therefore, a solution that can effectively balance low latency and reduced overhead is needed.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to user equipment (UE)-initiated uplink control information (UCI) reporting with respect to user equipment in mobile communications.

In one aspect, a method may involve an apparatus transmitting an uplink (UL) indication associated with an UL resource to a network node in an event that an uplink control information (UCI) reporting is triggered by the apparatus. The method may also involve the apparatus transmitting a UCI in the UL resource to the network node.

In one aspect, an apparatus may comprise a transceiver which, during operation, wirelessly communicates with a network node. The apparatus may also comprise a processor communicatively coupled to the transceiver. The processor, during operation, may perform operations comprising transmitting, via the transceiver, an uplink (UL) indication associated with an UL resource to a network node in an event that an uplink control information (UCI) reporting is triggered by the apparatus. The processor, during operation, may also perform operations comprising transmitting, via the transceiver, a UCI in the UL resource to the network node.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2A is a diagram depicting an example scenario of determining the UL resource for UCI reporting in accordance with implementations of the present disclosure.

FIG. 2B is a diagram depicting another example of scenarios for determining the UL resource for UCI reporting in accordance with implementations of the present disclosure.

FIG. 2C is a diagram depicting yet another example scenario of determining the UL resource for UCI reporting in accordance with implementations of the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to user equipment (UE)-initiated uplink control information (UCI) reporting in mobile communications, enabling low latency and low overhead. According to the present disclosure, a number of possible solutions may be implemented separately or jointly. That is, although these possible solutions may be described below separately, two or more of these possible solutions may be implemented in one combination or another.

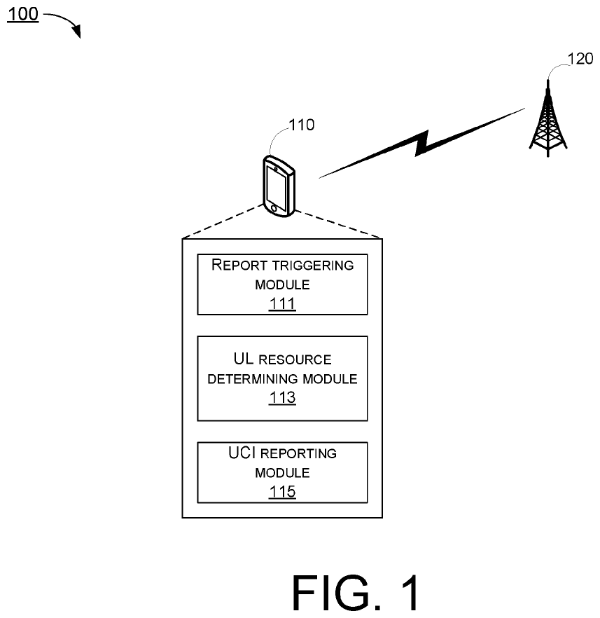

FIG. 1 illustrates an example scenario 100 of a communication environment in which various solutions and schemes in accordance with the present disclosure may be implemented. Scenario 100 involves a user equipment (UE) 110 in wireless communication with a wireless network (e.g., a 5G NR network) consisting of an access network and a core network. The UE 110 may be a smart phone, a wearable device, an IoT device, and a tablet, etc. Alternatively, the UE 110 may be a notebook (NB) or personal computer (PC) inserted or installed with a data card which includes a modem and radio frequency (RF) transceiver(s) to provide the functionality of wireless communication. The access network may include at least one base station (BS), such as the BS 120, which may provide communication coverage for a geographic coverage area where communications with the UE 110 is supported.

The UE 110 may comprise multiple functional modules that carry out different tasks in accordance with embodiments of the present disclosure, such as a report triggering module 111, an uplink (UL) resource determining module 113, and a UCI reporting module 115. Those modules may be implemented and configured by hardware, firmware, software, and any combination thereof. In this embodiment, the report triggering module 111 may trigger a UCI reporting without any network configurations. Alternatively, the report triggering module 111 may trigger the UCI reporting based on the network predefined events. The UCI reporting may be a channel state information (CSI) reporting, a beam reporting, or a combination thereof. Once UCI reporting is triggered, the UL resource determining module 113 determines one or more UL resources for transmitting the UCI. The UL resource(s) may be either dynamically scheduled or pre-configured by the BS 120. The UCI reporting module 115 may transmit the UCI comprising the CSI, the beam information, or both in the UL resource(s) determined by the UL resource determining module 113.

In one embodiment, the UE 110 may transmit an UL indication to inform the BS 120 that the UCI reporting is triggered, and to request the UL resource from the BS 120. The UL indication may include a PUCCH resource or a PRACH resource. For example, the UL indication is transmitted by a physical uplink control channel (PUCCH) or a physical random access channel (PRACH). Specifically, the UL indication may be provided by transmitting a PUCCH (e.g., scheduling request) or a preamble (e.g., PRACH)). After receiving the UL indication, the BS 120 may dynamically schedule a dedicated UL resource and sends a corresponding network indication to the UE 110. Then, the UE 110 may transmit the UCI in the UL resource indicated by the network indication. In one example, the UL resource scheduled by the BS 120 may be a physical uplink shared channel (PUSCH) resource, and the UE 110 may report the CSI and/or the beam information as the UCI on the PUSCH resource or include the CSI and/or the beam information in the medium access control-control element (MAC-CE) on the PUSCH resource.

In one embodiment, the UE 110 may transmit the UL indication by the PUCCH or the PRACH to inform the BS 120 that the UCI reporting is triggered, and to determine one or more pre-configured resources for UCI transmission. That is, the UL indication may include a PUCCH resource or a PRACH resource. In this embodiment, the pre-configured resources are configured by the BS 120 before it receives the UL indication sent by the UE 110, and the UE 110 may use the first one of the pre-configured resources, a subset of the pre-configured resources, or all the pre-configured resources for transmitting the UCI. The pre-configured resource may be a PUCCH resource or a configured grant PUSCH resource. In one example, the UE 110 may use a dedicated PUCCH resource by sending the UL indication and reports the CSI and/or the beam information as the UCI on the dedicated PUCCH resource. Alternatively, the UE 110 may use a configured grant PUSCH resource by sending the UL indication and report the CSI and/or the beam information as the UCI or include the CSI and/or the beam information in the MAC-CE on the configured grant PUSCH resource.

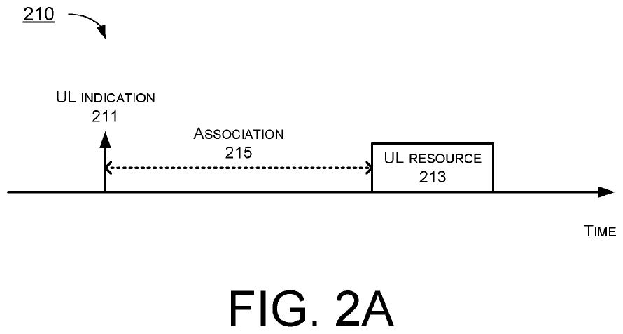

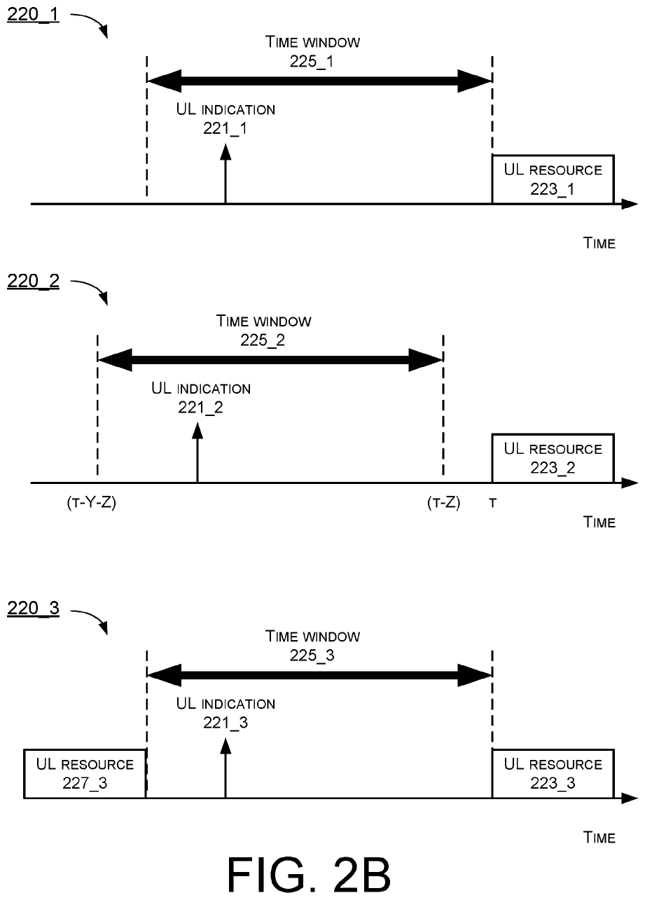

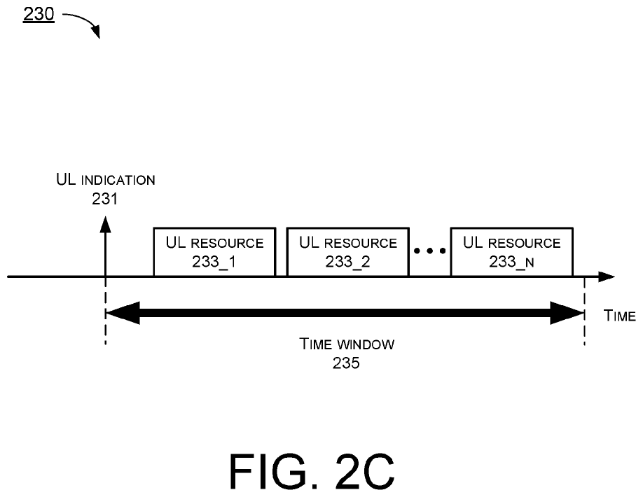

FIG. 2A is a diagram depicting an example scenario of determining the UL resource for UCI reporting in accordance with implementations of the present disclosure. In scenario 210, the UE 110 receives a configuration indicating an association 215 of the UL indication 211 and the UL resource 213 from the BS 120. If the UE 110 transmit the UL indication 211, then the associated UL resource 213 is used for transmitting the UCI. The configuration may be a radio resource control (RRC) configuration, and the resource for one UL indication may associated with one or more UL resources for UCI reporting. For example, if an UL indication is associated with just one pre-configured UL resource, the UE 110 transmits the UCI in that specific resource. In another example, if an UL indication is associated with multiple pre-configured UL resources, the UE 110 transmits the UCI in one of the associated UL resources (e.g., the first associated UL resource after the UL indication). In yet another example, if an UL indication is associated with multiple pre-configured UL resources, the UE 110 transmits the UCI in a subset of the associated UL resources or all the associated UL resources.

FIG. 2B illustrates another example of scenarios for determining the UL resource for UCI reporting. In this embodiment, the UL indication associated with the UL resource for transmitting the UCI is transmitted before a starting symbol of the UL resource. For example, the UL indication is transmitted in a time window associated with a starting symbol of the first pre-configured UL resource used for UCI transmission. As shown in scenario 220_1, the time window 225_1 is determined based on the starting symbol of the UL resource 223_1. When the BS 120 determines that the UL indication 221_1 is transmitted within the time window 225_1, it can conclude that the UE 110 is using the UL resource 223_1 to transmit the UCI. In scenario 220_2, it is assumed that the starting symbol of the UL resource 223_2 presents at time t, the time window 225_2 is defined as the duration with a length of Y symbols after the time (t-Y-Z) and before the time (t-Z). In which, Z represents the time required by the BS 120 to process an UL indication, and Y represents the valid duration of the occasion for transmitting the UL indication. When the BS 120 determines that the UL indication 221_2 is transmitted within the time window 225_2, it can conclude that the UE 110 is using the UL resource 223_2 to transmit the UCI. In scenario 220_3, the time window 225_3 is defined as the duration after the last symbol of the last UL resource 227_3 and before the starting symbol of the UL resource 223_3. When the BS 120 determines that the UL indication 221_3 is transmitted within the time window 225_3, it can conclude that the UE 110 is using the UL resource 223_3 to transmit the UCI.

FIG. 2C illustrates yet another example scenario for determining the UL resource for UCI reporting. As shown in scenario 230, the time window 235 is associated with a transmitting time of the UL indication 231 and there are n pre-configured UL resources 233_1 to 233_n in the time window 235. In one embodiment, the UL resource used for UCI transmission (i.e., the UL resource associated with the UL indication) is a most recent available transmission occasion of the pre-configured UL resources 233_1 to 233_n after a latest symbol of the UL indication 231. In another embodiment, any UL resource present in the time window 235 may be used for UCI transmission. To be specific, the starting time of the time window 235 is defined based on the transmitting time of the UL indication 231, and the duration of the time window 235 may be determined based on a network configuration. As shown in FIG. 2C, the pre-configured UL resources 233_1 to 233_n, with n being a positive integer, present within the time window 235 after the UL indication 231, and any of them can be used for UCI transmission. For example, if there is only one UL resource (e.g., n is equal to 1) within the time window 235, the UE 110 may report the UCI on the UL resource 233_1. In another example, if there are multiple UL resources within the time window 235 (e.g., n is greater than 1), the UE 110 may report the UCI on one of the UL resources within the time window 235 (e.g., the first UL resource after the UL indication 231). In yet another example, if there are multiple UL resources within the time window 235 (e.g., n is greater than 1), the UE 110 may report the UCI on the subset of the UL resources or all the UL resources within the time window 235.

Based on any of the scenarios illustrated in FIG. 2A to FIG. 2C, the BS 120 may identify the specific UL resource(s) employed by the UE 110 for UCI transmission.

It should be noted that a collision between an occasion of the UL resource for transmitting the UCI and an occasion of a scheduled PUSCH/PUCCH resource may occur if the BS 120 fails to receive the UL indication successfully or it needs to use the UL resource for another urgent purpose. The scheduled PUSCH/PUCCH resource is different from any pre-configured resources. Once the UE 110 determines that the occasion of the UL resource for transmitting the UCI is overlapped with the occasion of a scheduled resource in at least one orthogonal frequency division multiplexing (OFDM) symbol, the UE 110 may perform a collision handling. In one example, the UE 110 may prioritize the scheduled PUSCH/PUCCH. That is, the UE 110 may drop the occasion of the UL resource for transmitting the UCI. Alternatively, the UE 110 may drop one of the colliding occasions based on a downlink control information (DCI) or a configuration from the BS 120. In one example, the UE 110 may drop the occasion of the UL resource for transmitting the UCI and multiplexing the UCI in the scheduled PUSCH/PUCCH resource. That is, the UCI may be included in the scheduled PUSCH/PUCCH resource in an event that the UL resource for UCI transmission is determined to be dropped.

### Illustrative Implementations

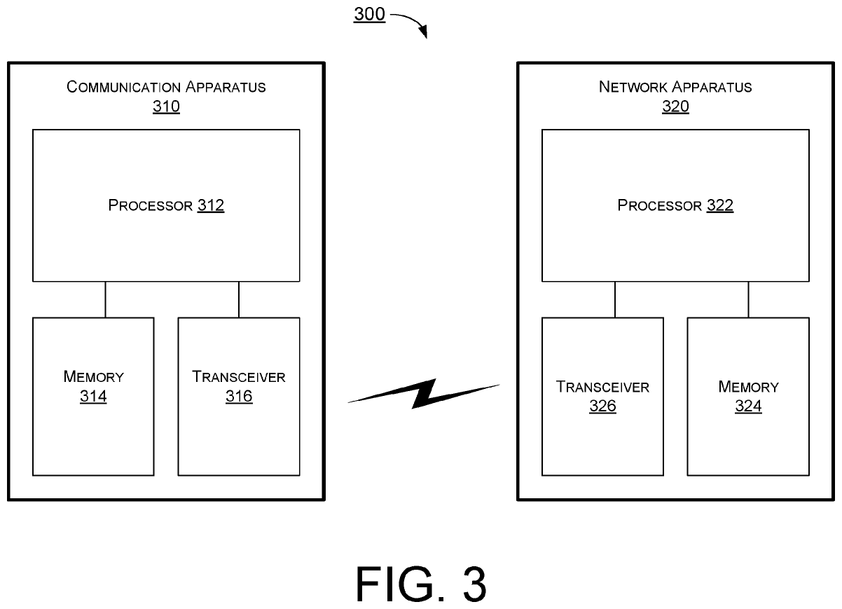

FIG. 3 illustrates an example communication system 300 having at least an example communication apparatus 310 and an example network apparatus 320 in accordance with an implementation of the present disclosure. The communication apparatus 310 may perform various functions to implement schemes, techniques, processes and methods described herein pertaining to UE-initiated UCI reporting in mobile communications, including scenarios/schemes described above as well as process 400 described below.

Communication apparatus 310 may be a part of an electronic apparatus, which may be a UE (e.g., the UE 110) such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station (e.g., the BS 120), a small cell, a router or a gateway. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Processor 322 may further include protocol stacks and a set of control functional modules and circuit. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of the processor 312 and processor 322 may be implemented in the form of one or more single-core processors, one or more multi-core processors, or one or more CISC processors. That is, even though a singular term “a processor” is used herein to refer to processor 312 and processor 322, each of the processor 312 and processor 322 may include multiple processors in some implementations and a single processor in other implementations in accordance with the present disclosure. In another aspect, each of the processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and processor 322 is a special-purpose machine specifically designed, arranged and configured to perform specific tasks in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein.

In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

For illustrative purposes and without limitation, descriptions of capabilities of the communication apparatus 310 is provided below with process 400. In which, the communication apparatus 310 is implemented in or as a communication apparatus or a UE, and network apparatus 320 is implemented in or as a network node of a communication network.

### Illustrative Processes

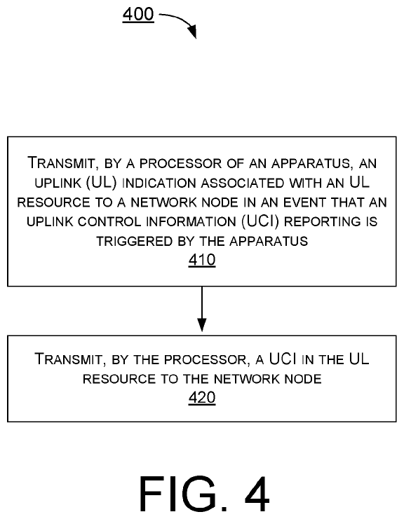

FIG. 4 illustrates an example process 400 in accordance with an implementation of the present disclosure. Process 400 may be an example implementation of above scenarios/schemes, whether partially or completely, with respect to UE-initiated UCI reporting in mobile communications. Process 400 may represent an aspect of implementation of features of communication apparatus 310. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE (e.g., UE 110) or machine type devices. Solely for illustrative purposes and without limitation, process 400 is described below in the context of communication apparatus 310 as a UE and network apparatus 320 as a network node. Process 400 may begin at block 410.

At block 410, process 400 may involve processor 312 of communication apparatus 310 transmitting, via transceiver 316, an uplink (UL) indication associated with an UL resource to a network node (e.g., network apparatus 320) in an event that an uplink control information (UCI) reporting is triggered by the communication apparatus 310. The UCI reporting may be one or a combination of the CSI reporting and the beam reporting. Process 400 may proceed from block 410 to block 420.

At block 420, process 400 may involve processor 312 transmitting, via transceiver 316, a UCL in the UL resource to the network node (e.g., network apparatus 320). The UCL may include one or a combination of the CSI and the beam information.

In some implementations, the UL resource is a PUSCH resource scheduled by a network indication after the network node receives the UL indication. Process 400 may further involve processor 312 receiving, via transceiver 316, the network indication for indicating the UL resource.

In some implementations, the UL indication may include a PUCCH resource or a PRACH resource.

In some implementations, process 400 may further involve processor 312 determining the UL resource among one or multiple pre-configured resources according to an association of the UL indication and the UL resource, wherein the one or multiple pre-configured resources are configured by the network node before the network node receives the UL indication.

In some implementations, process 400 may further involve processor 312 receiving, via transceiver 316, a configuration indicating the association of the UL indication and the UL resource from the network node.

In some implementations, the UL indication associated with the UL resource is transmitted before a starting symbol of the UL resource.

In some implementations, the UL resource associated with the UL indication is a most recent available transmission occasion of the one or multiple pre-configured resources after a latest symbol of the UL indication

In some implementations, the one or multiple pre-configured resources comprise one or more PUCCH resources, or one or more configured grant PUSCH resource.

In some implementations, process 400 may further involve processor 312 determining that an occasion of the UL resource for transmitting the UCI is overlapped with an occasion of a scheduled resource in at least one OFDM symbol. Process 400 may also involve processor 312 performing one of a first collision handling and a second collision handling. The first collision handling may comprise dropping the occasion of the UL resource for transmitting the UCI. The second collision handling may comprise dropping the occasion of the UL resource for transmitting the UCI, and multiplexing the UCI in the scheduled resource in an event that the UL resource for transmitting the UCI is determined to be dropped.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, an uplink (UL) indication associated with an UL resource to a network node in an event that an uplink control information (UCI) reporting is triggered by the apparatus; and
transmitting, by the processor, a UCI in the UL resource to the network node.

2. The method of claim 1, wherein the UL resource is a physical uplink shared channel (PUSCH) resource scheduled by a network indication after the network node receives the UL indication, and the method further comprises:
receiving, by the processor, the network indication for indicating the UL resource.

3. The method of claim 1, wherein the UL indication comprises a physical uplink control channel (PUCCH) resource or a physical random access channel (PRACH) resource.

4. The method of claim 1, further comprising:
determining, by the processor, the UL resource among one or multiple pre-configured resources according to an association of the UL indication and the UL resource, wherein the one or multiple pre-configured resources are configured by the network node before the network node receives the UL indication.

5. The method of claim 4, further comprising:
receiving, by the processor, a configuration indicating the association of the UL indication and the UL resource from the network node.

6. The method of claim 4, wherein the UL indication associated with the UL resource is transmitted before a starting symbol of the UL resource.

7. The method of claim 4, wherein the UL resource associated with the UL indication is a most recent available transmission occasion of the one or multiple pre-configured resources after a latest symbol of the UL indication.

8. The method of claim 4, wherein the one or multiple pre-configured resources comprise one or more PUCCH resources, or one or more configured grant PUSCH resources.

9. The method of claim 4, further comprising:
determining, by the processor, that an occasion of the UL resource for transmitting the UCI is overlapped with an occasion of a scheduled resource in at least one orthogonal frequency division multiplexing (OFDM) symbol; and
performing, by the processor, one of a first collision handling and a second collision handling, wherein:
the first collision handling comprises dropping the occasion of the UL resource for transmitting the UCI;
the second collision handling comprises dropping the occasion of the UL resource for transmitting the UCI, and multiplexing the UCI in the scheduled resource in an event that the UL resource for transmitting the UCI is determined to be dropped.

10. An apparatus, comprising:
a transceiver which, during operation, communicates wirelessly; and
a processor communicatively coupled to the transceiver such that, during operation, the processor performs operations comprising:
transmitting, via the transceiver, an uplink (UL) indication associated with an UL resource to a network node in an event that an uplink control information (UCI) reporting is triggered by the apparatus; and
transmitting, via the transceiver, a UCI in the UL resource to the network node.

11. The apparatus of claim 10, wherein the UL resource is a physical uplink shared channel (PUSCH) resource scheduled by a network indication after the network node receives the UL indication, and the processor, during operation, further performs operations comprising:
receiving, via the transceiver, the network indication for indicating the UL resource.

12. The apparatus of claim 10, wherein the UL indication comprises a physical uplink control channel (PUCCH) resource or a physical random access channel (PRACH) resource.

13. The apparatus of claim 10, wherein, during operation, the processor further performs operations comprising:
determining the UL resource among one or multiple pre-configured resources according to an association of the UL indication and the UL resource, wherein the one or multiple pre-configured resources are configured by the network node before the network node receives the UL indication.

14. The apparatus of claim 13, wherein, during operation, the processor further performs operations comprising:
receiving, via the transceiver, a configuration indicating the association of the UL indication and the UL resource from the network node.

15. The apparatus of claim 13, wherein the UL indication associated with the UL resource is transmitted before a starting symbol of the UL resource.

16. The apparatus of claim 13, wherein the UL resource associated with the UL indication is a most recent available transmission occasion of the one or multiple pre-configured resources after a latest symbol of the UL indication.

17. The apparatus of claim 13, wherein the one or multiple pre-configured resources comprise one or more PUCCH resources, or one or more configured grant PUSCH resources.

18. The apparatus of claim 13, wherein, during operation, the processor further performs operations comprising:
determining that an occasion of the UL resource for transmitting the UCI is overlapped with an occasion of a scheduled resource in at least one orthogonal frequency division multiplexing (OFDM) symbol; and
performing one of a first collision handling and a second collision handling, wherein:
the first collision handling comprises dropping the occasion of the UL resource for transmitting the UCI;
the second collision handling comprises dropping the occasion of the UL resource for transmitting the UCI, and multiplexing the UCI in the scheduled resource in an event that the UL resource for transmitting the UCI is determined to be dropped.
